(19) United States
(12) Patent Application Publication
(10) Pub. No.: US 2012/0014552 A1
(43) Pub. Date: Jan. 19, 2012

(54) MICROPHONE HOUSING WITH DISASSEMBLY PROTECTION FOR A CAP THEREOF

(76) Inventor: Zore YANG, Yunlin County (TW)

(21) Appl. No.: 12/836,814

(22) Filed: Jul. 15, 2010

(51) Int. Cl. H04R 9/08

(52) U.S. Cl. 381/361

(57) ABSTRACT

A grip of a microphone housing includes a cap coupling section formed with a first grip thread and a second grip thread that have opposite winding orientations and that are disposed respectively distal from and proximate to a distal grip end of the cap coupling section. A cap of the microphone housing includes a grip coupling section formed with a first cap thread and a second cap thread that are disposed respectively proximate to and distal From a distal cap end of the grip coupling section. The grip coupling section is configured to engage rotatably and coaxially the cap coupling section, the first cap thread is configured to bypass engagement with the second grip thread and to threadedly engage the first grip thread, and the second cap thread is configured to threadedly engage the second grip thread.

### BACKGROUND OF THE INVENTION

1. Field of the Invention

The invention relates to a microphone housing, and more particularly to a microphone housing with disassembly protection for a cap thereof.

2. Description of the Related Art

A conventional microphone housing may include a cap that is fastened to a grip by rotating the cap relative to the grip to engage a respective threaded portion of each of the cap and the grip. The cap may cover an audio pickup head of the microphone to protect delicate internal components. While the microphone is being used, a user out of nervousness or inattention may inadvertently unscrew the cap. Once loosened, the cap may fall off the microphone, allowing the internal components of the microphone to become damaged or lost.

### SUMMARY OF THE INVENTION

Therefore, an object of the present invention is to provide a microphone housing with disassembly protection for a cap thereof.

Accordingly, a microphone housing of this invention comprises a grip that includes a cap coupling section having a distal grip end. The cap coupling section is formed with a first grip thread and a second grip thread that have opposite winding orientations and that are disposed respectively distal from and proximate to the distal grip end.

The microphone housing further comprises a cap that includes a grip coupling section having a distal cap end. The grip coupling section is formed with a first cap thread and a second cap thread that are disposed respectively proximate to and distal from the distal cap end. The grip coupling section is configured to engage rotatably and coaxially the cap coupling section, and the first cap thread is configured to bypass engagement with the second grip thread and to threadedly engage the first grip thread. The second cap thread is configured to threadedly engage the second grip thread.

### BRIEF DESCRIPTION OF THE DRAWINGS

Other features and advantages of the present invention will be come apparent in the following detailed description of the preferred embodiment with reference to the accompanying drawings, of which:

FIG. 1 is a perspective view of a microphone housing, according to the preferred embodiment of the present invention;

FIG. 2 is an enlarged fragmentary partly exploded perspective view of the preferred embodiment;

FIG. 3 is an enlarged fragmentary exploded schematic partly sectional view of the preferred embodiment;

FIG. 4 is an enlarged fragmentary schematic sectional view illustrating first and second cap threads disposed between first and second grip threads of the preferred embodiment; and

FIG. 5 is an enlarged fragmentary schematic sectional view illustrating the first cap thread engaged with the first grip thread of the preferred embodiment.

### DETAILED DESCRIPTION OF THE PREFERRED EMBODIMENT

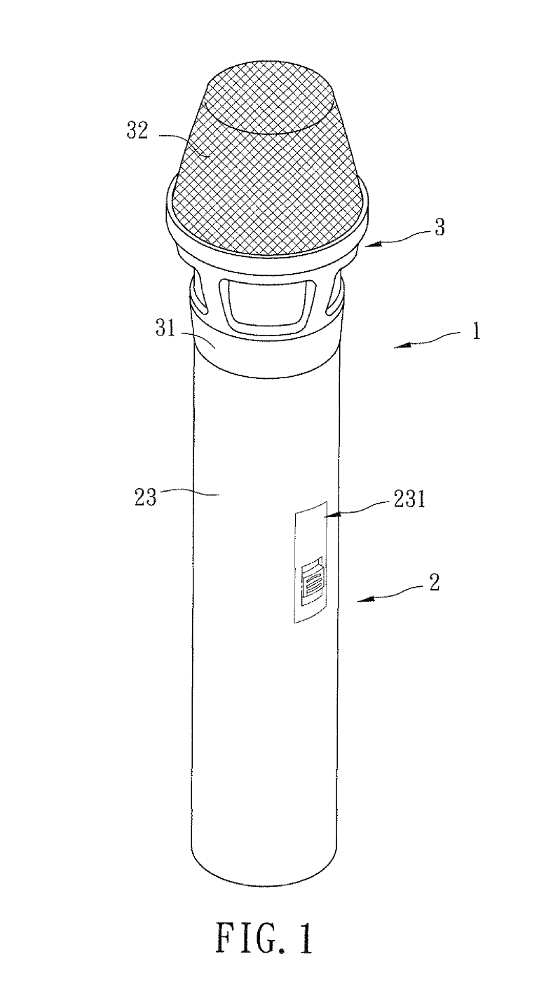

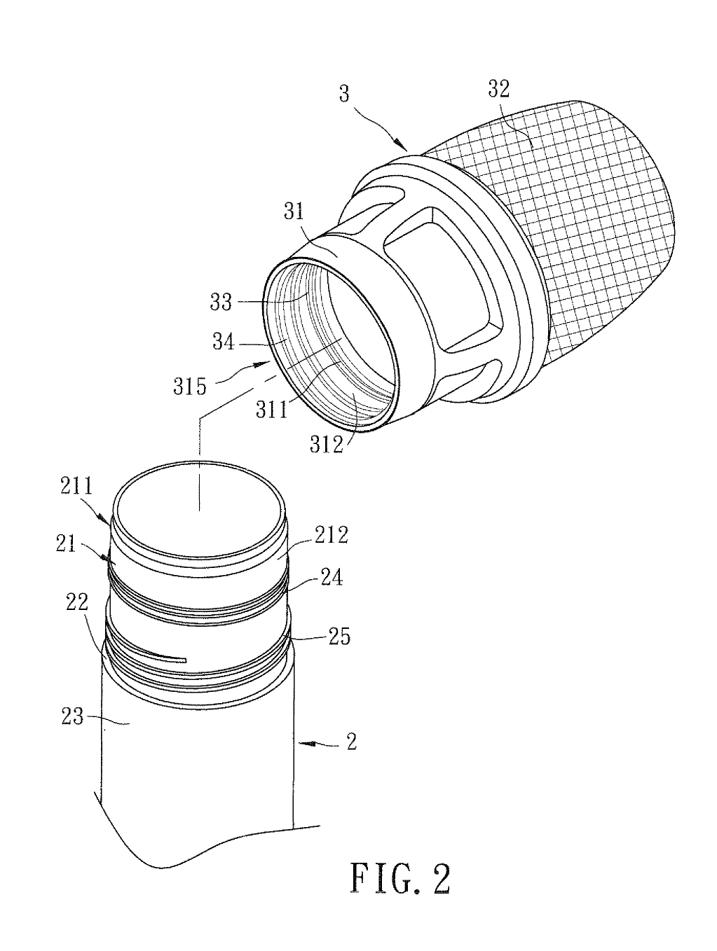

Referring to FIGS. 1, 2, and 3, the microphone housing 1 of the preferred embodiment of the present invention is used to contain elements, such as an audio pickup head, a battery, a circuit board (not shown), etc., of a microphone. The microphone housing 1 includes a grip 2, and a cap 3 configured to cover and engage a top end of the grip 2.

The grip 2 includes a cap coupling section 21 disposed at the top end of the grip 2 and having a distal grip end 211. In the preferred embodiment, the cap coupling section 21 serves as an audio pickup end of the grip 2. In variations of the preferred embodiment, the cap coupling section 21 may contain other microphone components or may have other functions. The cap coupling section 21 may be covered by the cap 3 when the cap 3 and the grip 2 are engaged.

The cap coupling section 21 is formed with a first grip thread 25 and a second grip thread 24 disposed respectively distal from and proximate to the distal grip end 211 with opposite winding orientations. In this embodiment, the first grip thread 25 and the second grip thread 24 respectively have first and second outer thread diameters 29, 28, and are formed on a grip surface 212 of the cap coupling section 21 that faces outward from the grip 2. The first grip thread 25 and the second grip thread 24 are spaced apart from each other on the cap coupling section 21 by a first axial distance 26. The cap coupling section 21 further has a first axial length 27 measured between distal sides of the first grip thread 25 and the second grip thread 24. The first outer thread diameter 29 of the first grip thread 25 is greater than the second outer thread diameter 28 of the second grip thread 24. The grip 2 further includes a shoulder 22 extending outward from the grip 2 and disposed at a bottom side of the cap coupling section 21 adjacent to the first grip thread 25. The grip 2 further includes a gripping wall section 23 extending from the shoulder 22 away from the cap coupling section 21 and formed with a switch opening 231.

The cap 3 includes a grip coupling section 31 having a distal cap end 315. The cap 3 further includes a perforated cover section 32 connected to a top side of the grip coupling section 31 distal from the distal cap end 315. The grip coupling section 31 surrounds a center axis of the cap 3, and has a cap surface 312. The cap surface 312 defines a grip coupling hole 311 and is configured to surround the cap coupling section 21. The distal cap end 315 defines an open end of the grip coupling hole 311.

The grip coupling section 31 is further formed with a first cap thread 34 and a second cap thread 33 that are disposed on the cap surface 312 respectively proximate to and distal from the distal cap end 315. The first cap thread 34 and the second cap thread 33 respectively have first and second inner thread diameters 316, 317, and are spaced apart on the grip coupling section 31 by a second axial distance 314. The grip coupling section 31 further has a second axial length 313 measured between distal sides of the first cap thread 34 and the second cap thread 33. The first inner thread diameter 316 of the first cap thread 34 may be greater than the second inner thread diameter 317 of the second cap thread 33.

The grip coupling section 31 is configured to engage rotatably and coaxially the cap coupling section 21. During assembly of the cap 3 and the grip 2, when the cap 3 is brought to engage the grip 2, the first cap thread 34 is configured to bypass engagement with the second grip thread 24. The second cap thread 33 then threadedly engages and disengages the second grip thread 24 before the first cap thread 34 threadedly engages the first grip thread 25. The distal cap end 315 and the shoulder 22 of the grip 2 are disposed to abut against each other when the cap 3 and the grip 2 are coupled together.

In this embodiment, the first axial distance 26 between the first grip thread 25 and the second grip thread 24 is greater than or equal to the second axial length 313 measured between the distal sides of the first cap thread 34 and the second cap thread 33. In addition, the first grip thread 25 and the second grip thread 24 are formed on the outward facing grip surface 212, while the first cap thread 34 and the second cap thread 33 are disposed on the cap surface 312, which faces inward and defines the grip coupling hole 311.

In variations of the preferred embodiment, the second axial distance 314 separating the first cap thread 34 and the second cap thread 33 may be greater than or equal to the first axial length 27 measured between the distal sides of the first grip thread 25 and the second grip thread 24. The grip surface 212 may face inward or outward while the cap surface 312 correspondingly faces outward or inward to enable threaded engagement between the cap 3 and the grip 2.

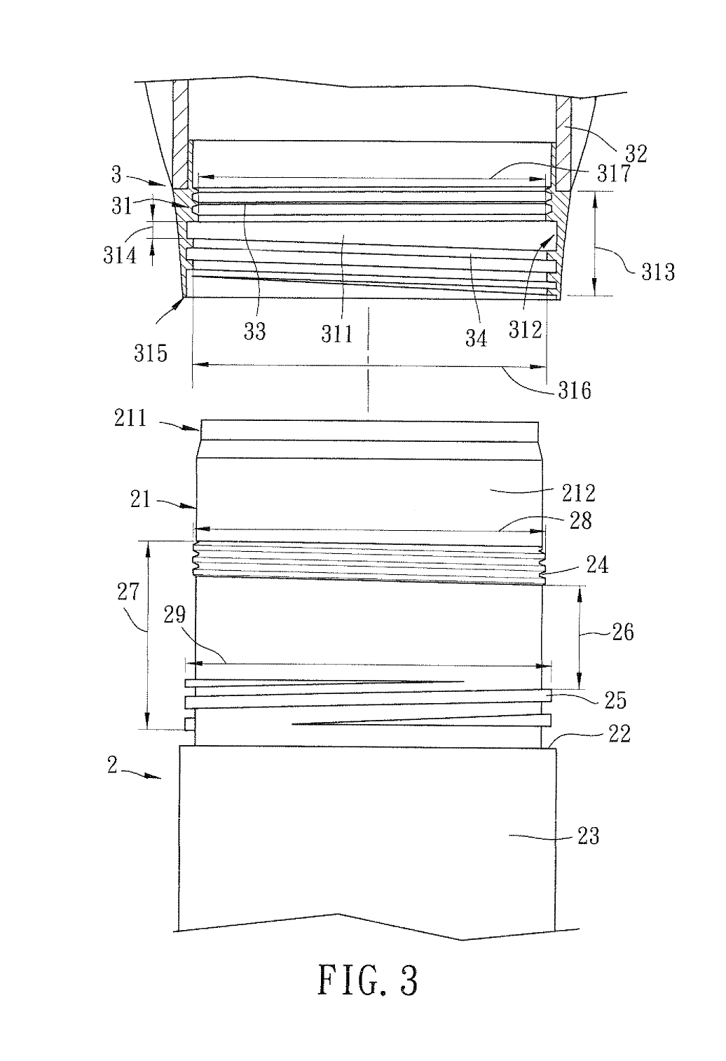

Referring to FIGS. 3, 4, and 5, during assembly of the microphone housing 1 of the preferred embodiment, the cap 3 is sheathed over the top of the grip 2 and moved downwards to bring the distal cap end 315 toward the shoulder 22 formed on the grip 2 at the bottom of the cap coupling section 21. As the cap 3 is moved downward over the grip 2, the greater size of the first inner thread diameter 316 relative to the second outer thread diameter 28 permits the first cap thread 34 to bypass threaded engagement while moving coaxially past the second grip thread 24.

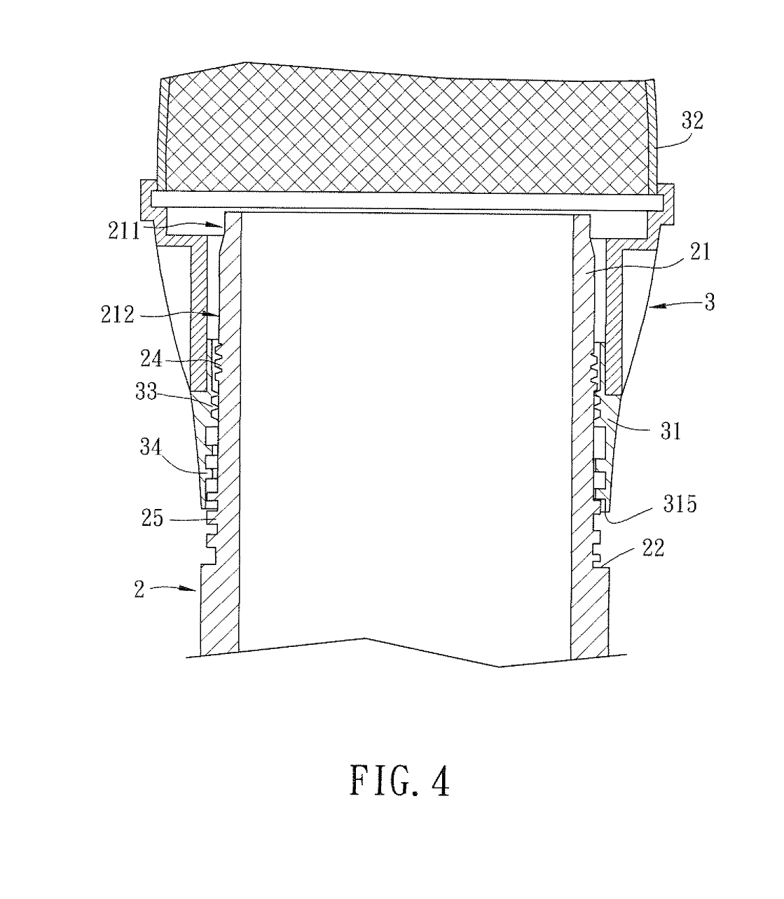

When a bottom side of the second cap thread 33 abuts against a top side of the second grip thread 24, the cap 3 may be rotated in a first rotational direction relative to the grip 2 to engage the second cap thread 33 and the second grip thread 24 and to continue advancing the distal cap end 315 towards the shoulder 22. Given that the second axial length 313 of the cap 3 is smaller than or equal to the first axial distance 26 of the grip 2, a top side of the second cap thread 33 separates from threaded engagement with a bottom edge of the second grip thread 24 before engagement between the first cap thread 34 on the cap 3 and the first grip thread 25 on the grip 2 is made possible, as best shown in FIG. 4. The first axial distance 26 may be sufficiently large to permit the first cap thread 34 and the second cap thread 33 to be displaced between the second grip thread 24 and the first grip thread 25 while the cap 3 remains sheathed over the grip 2.

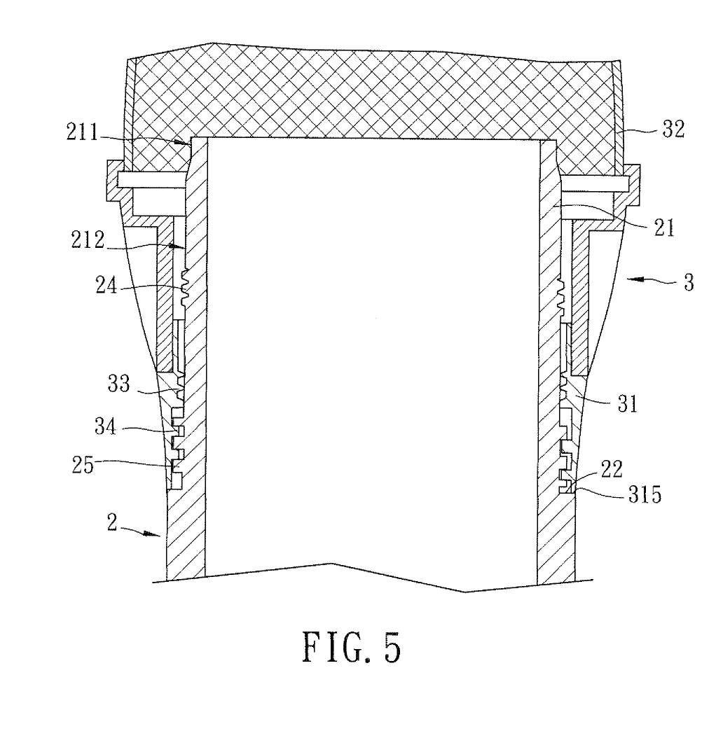

When a bottom side of the first cap thread 34 is moved to abut against a top side of the first grip thread 25, the cap 3 may be rotated in a second rotational direction relative to the grip 2 to engage the first cap thread 34 and the first grip thread 25. The second rotational direction is opposite to the first rotational direction. Assembly of the microphone housing 1 is completed when the distal cap end 315 has been moved to abut against the shoulder 22, as best shown in FIG. 5.

In order to detach the cap 3 from the grip 2 after the microphone housing 1 has been assembled, the cap 3 is loosened by being rotated in the first rotational direction relative to the grip 2. Sufficient rotation of the cap 3 separates the first cap thread 34 from the first grip thread 25 while the cap 3 remains coaxially movable relative to the grip 2. The top side of the second cap thread 33 is then moved to abut against the bottom side of the second grip thread 24. The cap 3 is then rotated opposite the first rotational direction to turn in the second rotational direction relative to the grip 2, causing the second cap thread 33 to threadedly engage the second grip thread 24. The cap 3 remains attached to the grip 2 until the bottom side of the second cap thread 33 separates from the top side of the second grip thread 24, disengaging the second cap thread 33 from the second grip thread 24.

The microphone housing 1 of the preferred embodiment of the present invention includes first and second grip threads 25, 24 and first and second cap threads 34, 35 with opposed winding orientations, the first axial distance 26 that is greater than or equal to the second axial length 313, and the cap 3 that disengages from the grip 2 after being successively rotated in opposite directions. The present invention can therefore prevent inadvertent removal of the cap 3 and potential damage to or loss of microphone components contained in the microphone housing 1.

While the present invention has been described in connection with what is considered the most practical and preferred embodiment, it is understood that this invention is not limited to the disclosed embodiment and its variations but is intended to cover various arrangements included within the spirit and scope of the broadest interpretation so as to encompass all such modifications and equivalent arrangements.

What is claimed is:

1. A microphone housing, comprising:
a grip that includes a cap coupling section having a distal grip end, said cap coupling section being formed with a first grip thread and a second grip thread that have opposite winding orientations and that are disposed respectively distal from and proximate to said distal grip end; and
a cap that includes a grip coupling section having a distal cap end, said grip coupling section being formed with a first cap thread and a second cap thread that are disposed respectively proximate to and distal from said distal cap end;
said grip coupling section being configured to engage rotatably and coaxially said cap coupling section, said first cap thread being configured to bypass engagement with said second grip thread and to threadedly engage said first grip thread, said second cap thread being configured to threadedly engage said second grip thread.

2. The microphone housing of claim 1, wherein when said cap is brought to couple with said grip, said second cap thread threadedly engages and disengages said second grip thread before said first cap thread threadedly engages said first grip thread.

3. The microphone housing of claim 2, wherein said first grip thread and said second grip thread are spaced apart from each other on said cap coupling section by an axial distance,
said grip coupling section having an axial length measured between distal sides of said first cap thread and said second cap thread,
said axial distance being not smaller than said axial length.

4. The microphone housing of claim 3, wherein said grip coupling section is formed with a grip coupling hole, said distal cap end defining an open end of said grip coupling hole, said grip coupling section having a cap surface defining said grip coupling hole and being configured to surround said cap coupling section, said first cap thread and said second cap thread being formed on said cap surface.

5. The microphone housing of claim 4, wherein said first cap thread has an inner thread diameter greater than an outer thread diameter of said second grip thread, thereby configuring said first cap thread to bypass engagement with said second grip thread.

6. The microphone housing of claim 5, wherein the inner thread diameter of said first cap thread is greater than an inner thread diameter of said second cap thread.

7. The microphone housing of claim 1, wherein said grip further includes a shoulder disposed at one end of said cap coupling section adjacent to said first grip thread and disposed to abut against said distal cap end when said first grip thread and said first cap thread are engaged.

8. The microphone housing of claim 7, wherein said cap coupling section serves as an audio pickup end of said grip, and said cap covers said cap coupling section when said grip coupling section engages said cap coupling section.

9. The microphone housing of claim 7, wherein said cap further includes a perforated cover section connected to said grip coupling section, and said grip further includes a gripping wall section that extends from said shoulder away from said cap coupling section.
